(19) United States
(12) Patent Application Publication
(10) Pub. No.: US 2026/0187120 A1
(43) Pub. Date: Jul. 2, 2026

(54) PERSONALIZED HEALTH EDUCATION PROVISION SYSTEM AND METHOD

(71) Applicant: Industrial Technology Research Institute, Hsinchu (TW)

(72) Inventors: Chang Yi Li, Kaohsiung City (TW); Jian-Ren Chen, Hsinchu County (TW); Ho-Hsin Lee, Hsinchu City (TW); Shang-Chih Hung, Hsinchu County (TW)

(73) Assignee: Industrial Technology Research Institute, Hsinchu (TW)

(21) Appl. No.: 19/004,460

(22) Filed: Dec. 30, 2024

(51) Int. Cl. G06F 16/334

(52) U.S. Cl. CPC G06F 16/3344

(57) ABSTRACT

This disclosure provides personalized health education provision system and method to help patients provide personalized health education information suitable for patients when they need health education services. In this way, it can be avoided that the health education content provided by healthcare professional is too broad and not applicable to individuals, and it can also prevent patients from being unable to accept the overly professional vocabulary explained by healthcare professional, resulting in ineffective health education. Through personalized health education provision system and method, patients can obtain health education information suitable for themselves at the appropriate time to achieve better health education results.

### TECHNICAL FIELD

The disclosure relates to a health education provision system and method, and in particularly relates to a personalized health education provision system and method.

### DESCRIPTION OF RELATED ART

In order to provide patients with good medical care, contemporary healthcare professional actively provide health education to patients after consultation and surgery. However, healthcare professional are often very familiar with each disease or the health education process after surgery, while each disease or the health education process after surgery is very unfamiliar to patients who are experiencing the relevant disease or surgery for the first time. The content presented by healthcare professional during health education may be too complicated for patients or presented too quickly. Consequently, the efficacy of health education may be compromised. If the patient does not further inquire with the healthcare professional to fully understand the health education content, it may lead to incorrect treatment, thereby affecting the recovery of the patient. Additionally, since each patient has different diseases or surgeries, even for the same surgery, different patients may have different health education treatment due to their respective basic physical conditions.

Therefore, how to provide easily comprehensible detailed health education information, precise answers and relevant suggestions, while providing personalized health guidance according to the specific requirements and circumstances of the patient, is an important topic.

### SUMMARY

The disclosure provides a personalized health education provision system and method, which provides personalized health education services through questions asked by patients and the medical records of the patient.

A personalized health education provision system of the disclosure includes a storage, a transceiver, and a processor. The storage stores a plurality of modules. The processor is coupled to the storage and the transceiver, and is configured to perform the following operation. A string is obtained through the transceiver. A query module in the plurality of modules is executed to obtain a first response according to the string. In response to a first distance between the first response and the string being greater than a first threshold, an auxiliary condition is obtained, and a second response is obtained according to the auxiliary condition. In response to the first distance between the first response and the string not being greater than the first threshold, the first response is converted into an image or voice to indicate health education.

The disclosure further provides a personalized health education provision method, including the following operation. A string is obtained through the transceiver. A query module in the plurality of modules is executed to obtain a first response according to the string. In response to a first distance between the first response and the string being greater than a first threshold, an auxiliary condition is obtained, and a second response is obtained according to the auxiliary condition. In response to the first distance between the first response and the string not being greater than the first threshold, the first response is converted into an image or voice to indicate health education.

Based on the above, this disclosure provides personalized health education provision system and method to help patients provide personalized health education information suitable for patients when they need health education services. In this way, it can be avoided that the health education content provided by healthcare professional is too broad and not applicable to individuals, and it can also prevent patients from being unable to accept the overly professional vocabulary explained by healthcare professional, resulting in ineffective health education. Through personalized health education provision system and method, patients can obtain health education information suitable for themselves at the appropriate time to achieve better health education results.

### BRIEF DESCRIPTION OF THE DRAWINGS

FIG. 1 is a schematic diagram of a personalized health education provision system of the disclosure.

FIG. 2 is a schematic flowchart of a personalized health education provision method of the disclosure.

FIG. 3 is a detailed schematic diagram of the personalized health education provision process of the disclosure.

FIG. 4A is a schematic diagram of question data input of the disclosure.

FIG. 4B is a schematic diagram of database expansion of the disclosure.

FIG. 4C is a schematic diagram of the output result of the disclosure.

FIG. 5A is a schematic diagram of the implementation of health education of the disclosure.

FIG. 5B is a schematic diagram of requiring additional information for the smooth implementation of health education of the disclosure.

### DESCRIPTION OF THE EMBODIMENTS

References of the exemplary embodiments of the disclosure are to be made in detail. Examples of the exemplary embodiments are illustrated in the accompanying drawings. Terms “first,” “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of the elements. In addition, wherever possible, elements/components with the same reference numerals in the drawings and embodiments represent the same or similar parts.

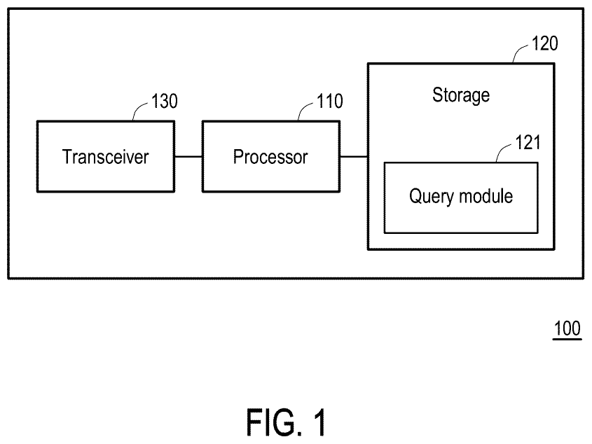

FIG. 1 is a schematic diagram of a personalized health education provision system provided by the disclosure. The personalized health education provision system 100 may include a processor 110, a storage 120, and a transceiver 130.

In embodiments of the disclosure, the processor is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. In the personalized health education provision system 100, the processor 110 can be coupled to the storage 120 and the transceiver 130, and the processor 110 can execute each module stored in the storage 120.

The storage 120 is, for example, any type of fixed or removable random access memory (RAM), read-only memory (ROM), flash memory, hard disk drive (HDD), solid state drive (SSD), or similar elements, or a combination of the elements thereof configured to store multiple modules or various applications executable by the processor 110. In this embodiment, the storage 120 may at least store the query module 121. In this embodiment, the storage 120 may further store the enhanced generated database.

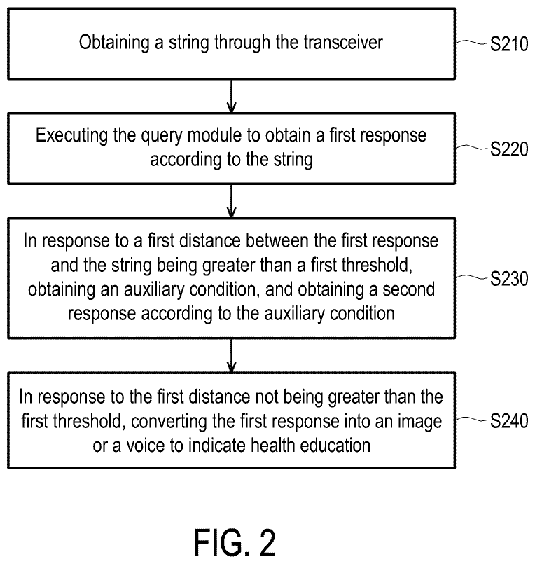

Referring to FIG. 2 simultaneously, FIG. 2 is a schematic flowchart of a personalized health education provision method of the disclosure, which can be implemented through the processor 110. In process S210, the processor 110 may obtain a string through the transceiver. In process S220, the processor 110 may execute the query module to obtain a first response according to the string. In process S230, in response to a first distance between the first response and the string being greater than a first threshold, the processor 110 may obtain an auxiliary condition, and obtain a second response according to the auxiliary condition. In process S240, in response to the first distance not being greater than the first threshold, the processor 110 may convert the first response into an image or a voice to indicate health education.

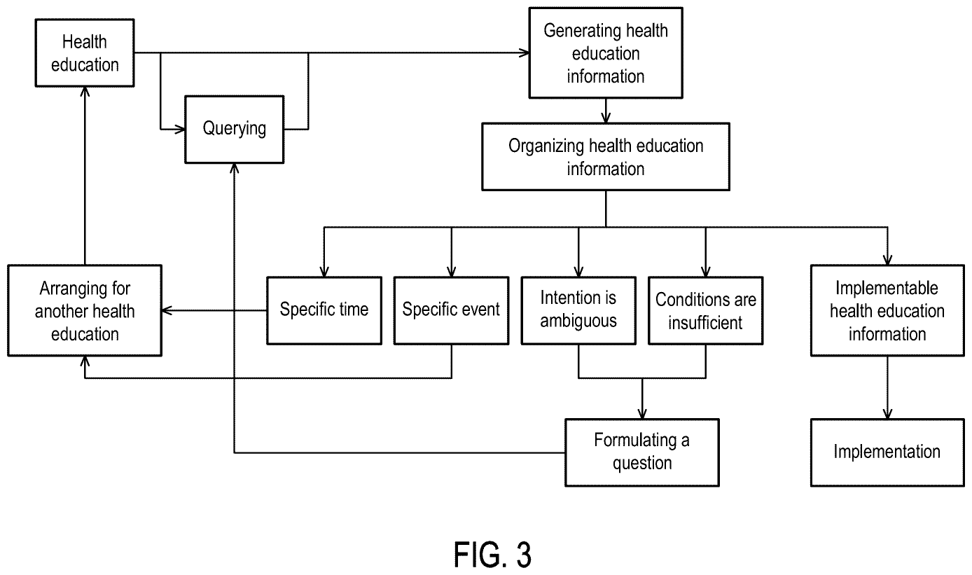

Referring to FIG. 3, FIG. 3 is a detailed schematic diagram of the personalized health education provision process of the disclosure. In the embodiment of the disclosure, when a health education behavior is triggered, the processor 110 of the personalized health education provision system 100 can directly generate health education information. In other embodiments of the disclosure, after triggering the health education behavior, the processor 110 may initially query, through the transceiver 130, whether the patient has any content they wish to understand. The processor 110 generates health education information according to the response of the patient and the conditions that trigger the health education behavior. For example, when the patient returns to the ward after surgery, a health education behavior can be triggered, and at this time, the processor 110 can generate health education information corresponding to the surgery.

Following the previous paragraph, after the processor 110 generates health education information, the processor 110 can organize the obtained health education information. For example, if a patient has a chronic disease such as hyperglycemia, the patient needs to pay attention to more health education information after surgery than a patient without hyperglycemia. Therefore, the processor 110 can organize the output health education information in a format that is easier for patients to understand. The processor 110 further determines whether the organized health education information is implementable health education, and when it is determined that the organized health education information is implementable, the processor 110 implements health education.

Continue referring to FIG. 3, when the processor 110 organizes the health education information and encounters insufficient health education information content to form effective content due to insufficient conditions, or when the processor 110 determines that the intention of triggering the health education is ambiguous, thereby causing processor 110 to sort out an excessively amount of health education content, in such circumstances, the processor 110 can form the situations encountered when organizing the health education information into questions and the processor 110 can ask these questions to the patient. For example, when a patient undergoes a gastrectomy surgery and the patient also asks about how to treat heart palpitations, at this time, the processor 110, in generating health education information, simultaneously generates content regarding post-surgery care for gastrectomy and treatment for heart palpitations. Since there is no correlated content between the post-surgery care of gastrectomy and the treatment for heart palpitations, the processor 110 determines that the intention is ambiguous and forms the query “Are you seeking content regarding post-surgery care for gastrectomy, or treatment for heart palpitations?” Subsequently, the processor 110 transmits this query to the patient via the transceiver 130.

Following the previous paragraph, another example is when a patient undergoes surgery, but the doctor's order only states large-area debridement, and the patient does not ask other questions, resulting in insufficient conditions. At this time, the processor 110 may only output the health education information of “pay attention to adhesion”, but it is apparent that this content is not enough to provide patients with an understanding of how to pay attention to adhesions. At this time, the processor 110 can form a question and ask the patient or nursing staff through the transceiver 130, such as “What is the debridement site and the specific area of debridement? Does the wound include the joints?” to further obtain more detailed conditions and facilitate the subsequent implementation of health education.

Continue referring to FIG. 3, in the embodiment of the disclosure, after the processor 110 organizes the health education information, the processor 110 determines that although the content of the health education information is sufficient, the health education information includes a health education threshold, so that the processor 110 cannot implement the health education. For example, when the health education information includes the content of “Take medicine 30 minutes after a meal”, that is, the health education information includes a specific event “having a meal” and a specific time “30 minutes after a meal”, then the processor 110 can determine whether the condition of “having a meal” has been met, and the processor 110 can determine whether the condition of “30 minutes after a meal” has been met. If the foregoing conditions are not met, the processor 110 may schedule to arrange for another health education. Therefore, the processor 110 can determine whether the patient currently meets the health education threshold. When the patient meets the health education threshold, the processor 110 can convert the health education information into an image through a display interface (not shown) to display to the patient to indicate the health education information. Alternatively, the processor 110 can broadcast the health education information to the patient in the form of voice through the transceiver 130.

Continue referring to FIG. 3, it should be understood that the determination by the processor 110 that the conditions are insufficient or the intention is ambiguous may be equivalent to the first distance between the first response and the string of the disclosure being greater than the first threshold. Therefore, the processor 110 needs to obtain the auxiliary conditions by querying the patient for further information. The processor 110 determines whether the conditions are insufficient or the intention is ambiguous by determining the candidate health education list number and the qualified health education list number obtained by the processor 110. The details of the candidate health education list and the qualified health education list will be described in the subsequent paragraphs.

In the embodiment of the disclosure, when the processor 110 determines that the conditions are insufficient, meaning that the candidate health education list number and the qualified health education list number obtained by the processor 110 according to the questions asked by the patient are insufficient to form a response to respond to the question, the processor 110 can obtain the coordinates of the ward location where the patient is located through positioning by a service robot (autonomous mobile robot, AMR). Since the patient data is input when the patient checks into the ward, when the processor 110 obtains the coordinates of the ward location, the patient data can be obtained according to the ward location. Thereby, the processor 110 can obtain the auxiliary conditions according to the patient data.

Following the previous paragraph, for example, when the question presented by the patient is “very uncomfortable”, since “uncomfortable” may be discomfort caused by various parts of the body, the information in the question is not sufficient for the processor 110 to obtain a solution or health education corresponding to what actually causes discomfort experienced by the patient. At this time, the processor 110 can obtain the location of the ward and the patient data of the corresponding ward according to the location of the service robot. The processor 110 further asks questions to the patient through the transceiver 130. For example, if the patient is hospitalized due to knee joint surgery, the processor 110 can further query the patient through the transceiver 130: “Are you feeling discomfort in the knee joint?” Thereby, the processor 110 can obtain the auxiliary conditions according to further answers of the patient and make corresponding health education responses.

In the embodiment of the disclosure, when the processor 110 determines that the intention is ambiguous, that is, the qualified health education list is too small but the candidate health education list is sufficient, at this time the processor 110 can extract information that the patient may be interested in from the obtained candidate health education list through the transceiver 130 and ask further questions, thereby obtaining more specific questions that the patient wants to ask. For example, when the patient asks “What should be done after knee joint surgery?”, the processor 110 sorts out the post-knee joint surgery information through the candidate health education list, including: turning and positioning techniques after knee joint surgery, knee joint surgery rehabilitation methods, fall prevention measures after knee joint surgery. However, since the number of detailed health education data in the aforementioned three pieces of information is too large, and there is no direct correlation between the question of the patient and the aforementioned three pieces of information (i.e., the qualified health education threshold is not passed), the processor 110 integrates the candidate health education content, and queries through the transceiver 130: “Would you like to know about post-surgery turning techniques, rehabilitation methods, or fall prevention measures following surgery?” The processor 110 obtains auxiliary conditions according to further responses of the patient for subsequent health education.

In an embodiment of the disclosure, the processor 110 can execute the natural language model stored in the storage 120 to extract at least one keyword from the received question string, and the processor 110 may further execute the query module to obtain a first response according to at least one keyword. Specifically, the processor 110 may, for example, execute a natural language model to extract keywords such as “after gastrectomy”, “diet control”, “prevention of rapid food digestion” and “dumping syndrome” from the question: “What is the diet control after gastrectomy? How to prevent dumping syndrome caused by rapid food digestion?” The processor 110 then executes the query module to obtain a response of “To prevent dumping syndrome after gastrectomy, it is recommended to: (1.) Lie down and rest for 30 minutes to 1 hour after eating. (2) Eat less starchy and high-sugar foods. (3) Adjust the meal consumption order and avoid liquid foods. (4) Consume meals in small portions with increased frequency.”

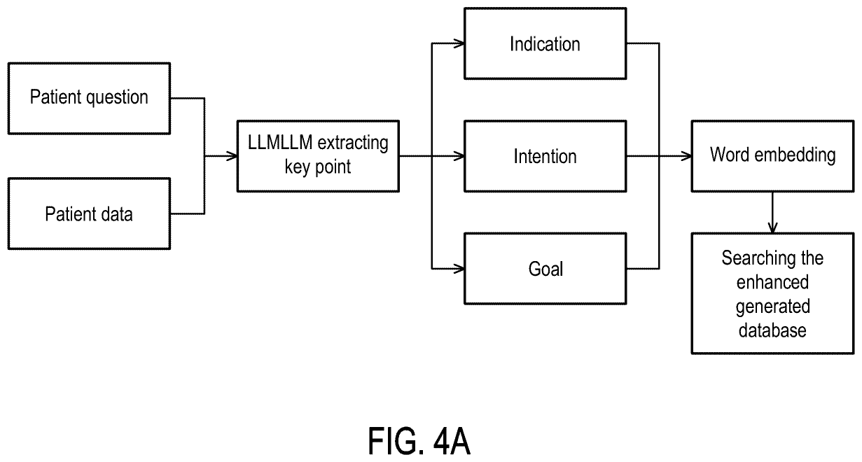

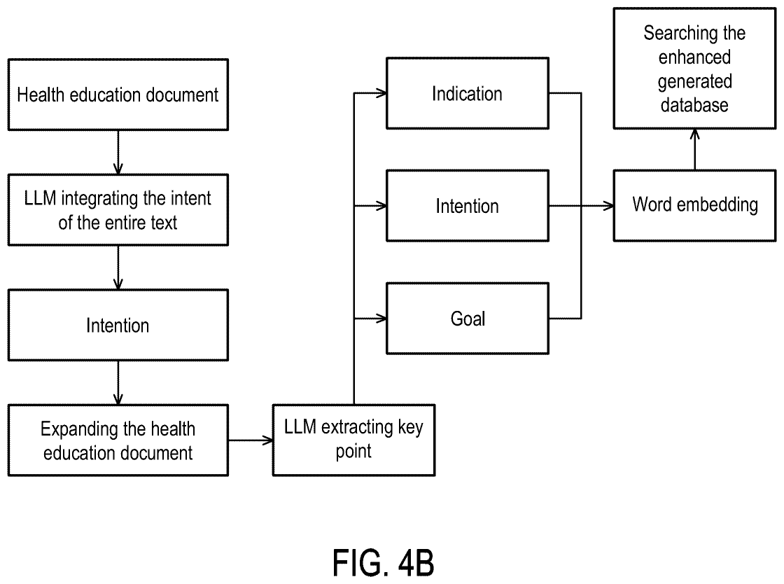

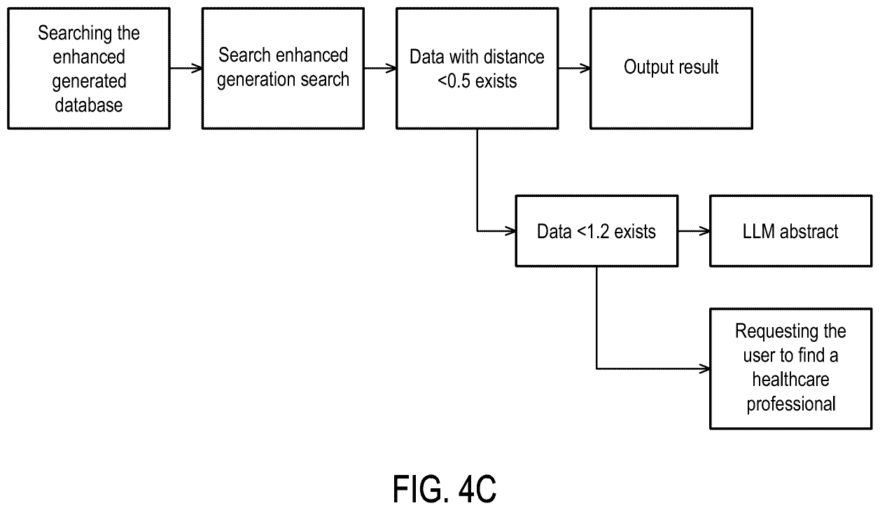

Referring to FIG. 4A, FIG. 4A is a schematic diagram of question data input of the disclosure. In FIG. 4A, first the processor 110 may receive question data input. The question data includes questions asked by patients and patient information (e.g., medical records). In other embodiments of the disclosure, the question data may also include questions asked by the healthcare professional. After the processor 110 receives the question data, the processor 110 can execute a large language model (LLM) to extract key points. Thereby, the processor 110 may obtain at least one key point among the indication, intention, and goal included in the keywords to perform word embedding. That is, the processor 110 can convert the keywords into questions or search terms according to the keywords. Thereby, the processor 110 can use the word-embedded string to search the enhanced generated database.

Referring to FIG. 4B, FIG. 4B is a schematic diagram of database expansion of the disclosure. In FIG. 4B, the processor 110 can read at least one health education document that is already stored in the database, and the processor 110 can integrate the intention of the full text from the health education document by executing a large language model. For example, when the health education document includes the content of “post-surgery diet” and the occurrence count of “post-surgery diet” is greater than the count threshold, the processor 110 may determine that the intention of this health education document is to provide a dietary reference for patients after surgery. At this time, the processor 110 can expand the content of the health education document based on the keyword “post-surgery diet”. For example, the original health education document may only state: “Lie down and rest for 30 minutes to 1 hour after eating”. However, after the processor 110 searches other health education documents according to the keyword “post-surgery diet”, the processor 110 obtains content related to post-surgery diet, such as “Eat less starchy and high-sugar foods.”, “Adjust the meal consumption order and avoid liquid foods.”, “Consume meals in small portions with increased frequency.”, etc. At this time, the processor 110 can supplement the original health education document with content related to “post-surgery diet” obtained from other health education documents to expand the content of the health education document.

Continue referring to FIG. 4B, the processor 110 may execute a natural language model to extract key points from the expanded health education document. Specifically, the expanded health education document may include the indication of health education, the intention of health education, and the goal of health education, and the processor 110 may extract at least one of the indication, the intention, and the goal from the expanded health education document to perform word embedding. That is, the processor 110 can convert the keywords into questions or search terms according to the keywords. Thereby, the processor 110 can use the word-embedded string to search the enhanced generated database.

Referring to FIG. 4C, FIG. 4C is a schematic diagram of the output result of the disclosure. Referring to FIG. 4A and FIG. 4B in conjunction, the word embeddings generated in FIG. 4A and FIG. 4B respectively are used to search the enhanced generated database and can be used for the search enhanced generation search in FIG. 4C. When there exists a distance less than 0.5 between the data obtained by the search and the question string, the processor 110 may output the obtained data as a result. That is, when the obtained data can answer the question string, the patient or healthcare professional (user) receiving the data will not consider that the answer provided by the personalized health education provision system 100 is irrelevant. Therefore, the result obtained from the search can be output to the user to indicate health education. It should be understood that when the processor 110 sorts out all the search data whose distance from the question string is less than 0.5, the processor 110 may organize the data into a response prototype, and the processor 110 may further simplify the response prototype to generate a response and output the response according to the response prototype.

Continue referring to FIG. 4C, when there exists a distance not less than 0.5 between the data obtained by the search and the question string, and there exists a distance less than 1.2 between the data and the question string, the processor 110 may output an abstract of the data obtained from the large language model via the transceiver 130. Since the distance that exists between the data obtained by the search and the question string of the processor 110 is not less than 0.5, the number of existing data may be larger than the number of data with the distance less than 0.5. If all data is output, the user may not be able to understand the key points of health education, and some data that is not relevant to the question may exist. Therefore, the processor 110 can only output an abstract of the health education for user reference, and when the user intends to further understand the detailed content under the abstract, the processor 110 can provide more complete information for the user to review.

Continue referring to FIG. 4C, if the distance between the data obtained by the search and the question string is not less than 1.2, the processor 110 can request the user to query a healthcare professional through the transceiver 130. At this time, the patient may not be clear about the question they intend to understand, the patient may not know how to ask the question, or the patient may be experiencing complications without knowing it. Therefore, it is necessary for the patient to ask questions through the assistance of the healthcare professional, alternatively, a healthcare professional who is more familiar with the current conditions of the patient may send a second question string to obtain an accurate response.

In an embodiment of the disclosure, the method for calculating the distance between the the data obtained by the search and the question string may include the following operation. The processor 110 converts the keywords of the question string into a question vector. The processor 110 converts the data in the enhanced generated database into a data vector. The processor 110 compares the question vector and the data vector to obtain a response. The method by which the processor 110 compares the question vector and the data vector may include the following operation. The distance between the question vector and the data vector is calculated by L2 similarity or Cosine similarity. In the embodiment of the disclosure, Cosine similarity is used as the distance calculation tool. In other embodiments of the disclosure, other methods may be used to calculate the distance between the question vector and the data vector.

In other embodiments of the disclosure, the processor 110 can generate at least one derived keyword according to the keywords obtained from the question string. In this way, the processor 110 can search for a greater number of data in the enhanced generated database through derived keyword searches compared to searches using only keywords. Therefore, the processor 110 can provide the user with more information related to the question string, thereby establishing a more robust intention linkage. The same as above, after the processor 110 obtains the data through the derived keyword, the processor 110 generates a response prototype, which is further simplified into a response for output according to the response prototype.

In the embodiment of the disclosure, in addition to searching the first enhanced generated database according to keywords, the processor 110 can also search the second enhanced generated database according to keywords to obtain a response prototype. In this way, the processor 110 can expand the intention of the question string to obtain more data. It should be understood that the first enhanced database and the second enhanced database may include different illness but include the same precautions. For example, gastrectomy and appendectomy are surgeries to remove different organs. However, since both are surgeries to remove organs, it is also necessary to pay attention to dietary adjustments after the loss of some organs.

In one embodiment of the disclosure, the aforementioned intention linkage and intention expansion can be performed sequentially. That is, the processor 110 may first generate derivative keywords for the keywords to perform intention linkage, and use the keywords and the derivative keywords to search the first enhanced database and the second enhanced database for intention expansion. In this way, the processor 110 can obtain more complete and richer health education information for user reference.

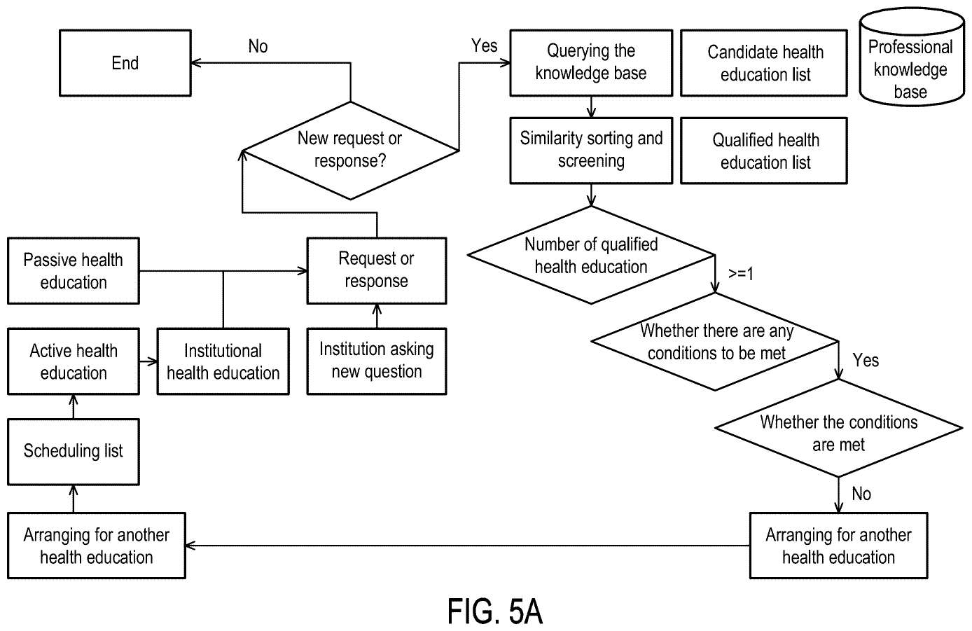

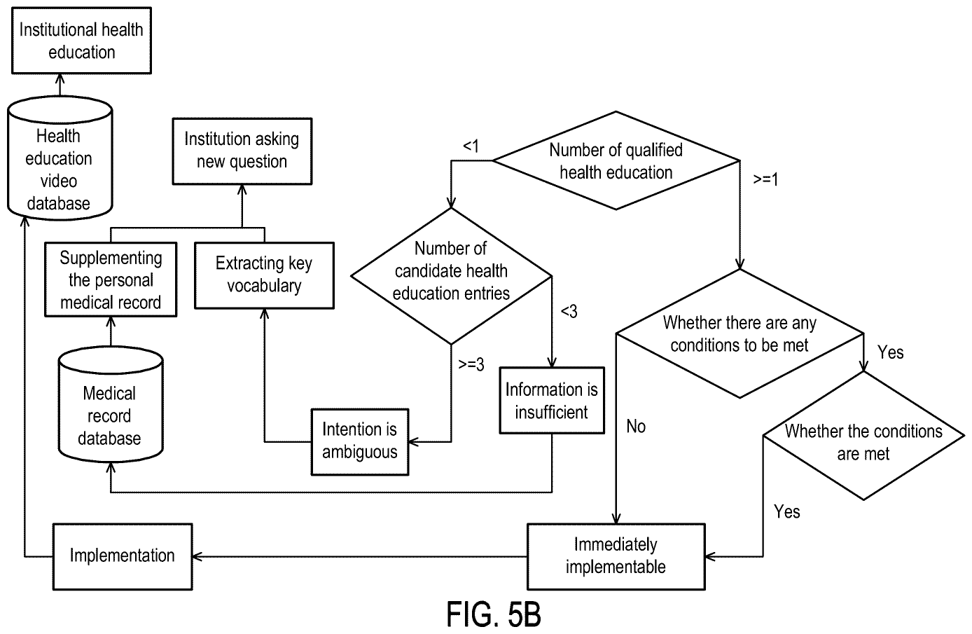

Referring to FIG. 5A, FIG. 5A is a schematic diagram of the implementation of health education of the disclosure. When passive health education is triggered, that is, for example, the patient has just completed surgery and returned to the ward from the recovery room, the personalized health education provision system 100 may be requested or configured to respond to content related to passive health education. In the aforementioned example, the personalized health education provision system 100 may be requested to provide post-surgery health education information. At this time, the processor 110 can query the professional knowledge base to obtain the candidate health education list. Then, the processor 110 can perform similarity sorting and screening to extract a qualified health education list from the candidate health education list. For example, the processor 110 may compare the content of the health education list and the vector distance between the question strings to determine whether the candidate health education list is a qualified health education list.

Following the previous paragraph, if the number of qualified health education list is greater than or equal to one, the processor 110 determines whether the health education conditions are met. When the health education conditions are met, the processor 110 may implement health education. If the health education conditions are not met, the processor 110 can arrange for another health education and enter the health education plan into the scheduling list to perform active health education when the health education conditions are met. When the processor 110 performs active health education, it can also be combined with institutional health education so that health education can proceed more smoothly. Since the processor 110 has included the health education into the schedule, the institution can pre-arrange nursing staff to assist in the health education so that the health education can proceed smoothly. The health education conditions may include, for example, the patient has consumed food for more than 30 minutes. Any and all situations where a patient is required to perform a specific behavior before health education can be provided, the specific behavior belongs to a health education condition of the disclosure.

Continue referring to FIG. 5A, when the nursing staff deems that the information of passive health education is insufficient, the institution can ask new questions to ensure that the patient can receive more complete health education information.

Continue referring to FIG. 5A, after completing the aforementioned health education, the processor 110 can ask the patient through the transceiver 130 whether there are any other questions. When the processor 110 receives a response string of “no questions” or a response string equivalent to no other questions, the processor 110 may end this health education.

Referring to FIG. 5B, FIG. 5B is a schematic diagram of requiring additional information for the smooth implementation of health education of the disclosure, which can continue the process after determining the number of qualified health education of FIG. 5A. When the number of qualified health education is greater than or equal to one, the processor 110 can determine whether there are any conditions to be met, and when no conditions need to be met, or when there are conditions to be met and the conditions have been met, the processor 110 can immediately implement health education to the patient. For example, the processor 110 can read the health education video database and obtain the corresponding qualified health education video, which can then be played for the patient through a display interface (not shown) to perform the institutional health education.

Continue referring to FIG. 5B, when the number of qualified health education is less than 1 and the number of candidate health education entries is less than 3, the processor 110 can determine that the information of the question string is insufficient. At this time, the processor 110 can obtain the medical records of the patient from the medical record database of the patient to supplement the personal medical record, and ultimately form a new question string to re-inquire, so that the processor 110 re-queries the knowledge base to ultimately obtain health education content that meets the requirements of the patient. Supplementary personal medical record information may include the surgical procedure of the patient, the disease name of the patient, and the age and gender of the patient. All physiological information of the patient belongs to the scope of personal medical record information of this disclosure.

Following the previous paragraph, if the number of candidate health education entries is greater than or equal to 3, the processor 110 may determine that the intention of the question is ambiguous. That is, the question string according to which the processor 110 queries the database is not accurate enough, resulting in an excessive amount of data obtained. At this time, the processor 110 can further extract key vocabulary from the question string to ask the patient with the key vocabulary, and the patient can provide further question strings according to the key vocabulary, so that the processor 110 can ultimately narrow the scope to obtain the health education information required by the patient. In embodiments of the disclosure, the method for extracting key vocabulary may include using large language model (LLM), latent Dirichlet allocation (LDA), and named entity recognition (NER).

In the embodiment of the disclosure, when the number of qualified health education is less than 1 and the number of candidate health education is less than 3, it means that there is insufficient information. At this time, it also means that the distance between the question string and the obtained health education information is greater than the first threshold. Therefore, the processor 110 can obtain the auxiliary condition from the medical record of the patient, and the processor 110 can further confirm the intention of the question string according to the auxiliary condition to perform the next round of knowledge base search to obtain a second response. It should be understood that compared with the first response, the second response may better meet the current needs of the patient for health education information content. As mentioned in the previous embodiment, the process for when the question presented by the patient is “very uncomfortable” will not be repeated herein.

In the embodiment of the disclosure, when the number of qualified health education is less than 1 and the number of candidate health education is less than 3, in addition to obtaining the auxiliary condition according to the medical record of the patient to perform a knowledge base search in the next round to obtain a corresponding candidate health education list to form a second response, the processor 110 can also directly obtain the second string of questions asked by the patient through the transceiver 130, and the processor 110 obtains a candidate health education list according to the second string to form a second response.

In the embodiment of the disclosure, even if the question string asked by the user is sufficiently accurate and the processor 110 provides health education information that is suitable for the user according to the question string, the processor 110 can still receive a second string belonging to another question through the transceiver 130, and the processor 110 can execute the query module to obtain the second health education corresponding to the second string according to the second string including an interrogative word. Referring to FIG. 5A again, here, the active health education is shown in FIG. 5A, that is, the processor 110 can ask the user a question such as “Do you have another question?” through the transceiver 130, and if the user asks another question, the processor 110 can execute the process shown in FIG. 2 again to obtain health education content corresponding to the other question.

In the embodiment of the disclosure, the processor 110 can receive a voice message through the transceiver 130, and the processor 110 converts the voice message into a question string to search for health education information. The processor 110 may also receive a text message input by the user as a question string and search for health education information.

To sum up, this disclosure provides personalized health education provision system and method to help patients provide personalized health education information suitable for patients when they need health education services. In this way, it can be avoided that the health education content provided by healthcare professional is too broad and not applicable to individuals, and it can also prevent patients from being unable to accept the overly professional vocabulary explained by healthcare professional, resulting in ineffective health education. Through personalized health education provision system and method, patients can obtain health education information suitable for themselves at the appropriate time to achieve better health education results.

What is claimed is:

1. A personalized health education provision system, comprising:
a storage, storing a plurality of modules;
a transceiver; and
a processor, coupled to the storage and the transceiver, and configured to:
obtain a string through the transceiver;
execute a query module in the plurality of modules to obtain a first response according to the string;
in response to a first distance between the first response and the string being greater than a first threshold, obtain an auxiliary condition, and obtain a second response according to the auxiliary condition; and
in response to the first distance not being greater than the first threshold, convert the first response into an image or a voice to indicate health education.

2. The personalized health education provision system according to claim 1, wherein the processor is further configured to:
in response to meeting a health education threshold, indicate the health education.

3. The personalized health education provision system according to claim 1, wherein the processor is further configured to:
execute a natural language model to extract at least one keyword from the string; and
execute the query module to obtain the first response according to the at least one keyword.

4. The personalized health education provision system according to claim 3, wherein the storage further stores an enhanced generated database, wherein the processor is further configured to:
search the enhanced generated database according to the at least one keyword to obtain at least one response prototype; and
generate the first response according to the at least one response prototype.

5. The personalized health education provision system according to claim 4, wherein the processor is further configured to:
convert the at least one keyword into at least one question vector, and convert at least one data in the enhanced generated database into at least one data vector; and
compare the at least one question vector and the at least one data vector to obtain the first response.

6. The personalized health education provision system according to claim 4, wherein the processor is further configured to:
generate at least one derived keyword according to the at least one keyword; and
search the enhanced generated database according to the at least one derived keyword to obtain the at least one response prototype.

7. The personalized health education provision system according to claim 4, wherein the processor is further configured to:
search a second enhanced generated database according to the at least one keyword to obtain the at least one response prototype.

8. The personalized health education provision system according to claim 1, wherein the processor is further configured to:
in response to the first distance being greater than the first threshold, obtain the auxiliary condition according to a medical record; and
further confirm an intention represented by the string according to the auxiliary condition to obtain the second response.

9. The personalized health education provision system according to claim 8, wherein the processor is further configured to:
in response to the first distance being greater than the first threshold, obtain a plurality of candidate health education lists; and
obtain a corresponding first candidate health education list according to the auxiliary condition to form the second response, or
obtain a second string through the transceiver, and obtain the corresponding first candidate health education list according to the second string to form the second response.

10. The personalized health education provision system according to claim 1, wherein the processor is further configured to:
in response to indicating the health education, obtain a second string through the transceiver; and
in response to the second string comprising an interrogative word, execute the query module to obtain second health education corresponding to the second string.

11. A personalized health education provision method, comprising:
obtaining a string through a transceiver;
executing a query module to obtain a first response according to the string;
in response to a first distance between the first response and the string being greater than a first threshold, obtaining an auxiliary condition, and obtaining a second response according to the auxiliary condition; and
in response to the first distance not being greater than the first threshold, converting the first response into an image or a voice to indicate health education.

12. The personalized health education provision method according to claim 11, further comprising:
in response to meeting a health education threshold, indicating the health education.

13. The personalized health education provision method according to claim 11, further comprising:
executing a natural language model to extract at least one keyword from the string; and
executing the query module to obtain the first response according to the at least one keyword.

14. The personalized health education provision method according to claim 13, further comprising:
searching an enhanced generated database according to the at least one keyword to obtain at least one response prototype; and
generating the first response according to the at least one response prototype.

15. The personalized health education provision method according to claim 14, further comprising:
converting the at least one keyword into at least one question vector, and converting at least one data in the enhanced generated database into at least one data vector; and
comparing the at least one question vector and the at least one data vector to obtain the first response.

16. The personalized health education provision method according to claim 14, further comprising:
generating at least one derived keyword according to the at least one keyword; and
searching the enhanced generated database according to the at least one derived keyword to obtain the at least one response prototype.

17. The personalized health education provision method according to claim 14, further comprising:
searching a second enhanced generated database according to the at least one keyword to obtain the at least one response prototype.

18. The personalized health education provision method according to claim 11, further comprising:
in response to the first distance being greater than the first threshold, obtaining the auxiliary condition according to a medical record; and
further confirming an intention represented by the string according to the auxiliary condition to obtain the second response.

19. The personalized health education provision method according to claim 18, further comprising:
in response to the first distance being greater than the first threshold, obtaining a plurality of candidate health education lists; and
obtaining a corresponding first candidate health education list according to the auxiliary condition to form the second response, or
obtaining a second string through the transceiver, and obtain the corresponding first candidate health education list according to the second string to form the second response.

20. The personalized health education provision method according to claim 11, further comprising:
in response to indicating the health education, obtaining a second string through the transceiver; and
in response to the second string comprising an interrogative word, executing the query module to obtain second health education corresponding to the second string.
